(19) United States
(12) Patent Application Publication
(10) Pub. No.: US 2024/0206018 A1
(43) Pub. Date: Jun. 20, 2024

(54) FILM HEATER

(71) Applicant: DENSO CORPORATION, Kariya-City (JP)

(72) Inventor: Taro OGURA, Kariya-City (JP)

(21) Appl. No.: 18/589,716

(22) Filed: Feb. 28, 2024

Related U.S. Application Data
(63) Continuation of application No. PCT/JP2022/036687, filed on Sep. 30, 2022.

(30) Foreign Application Priority Data
Oct. 15, 2021 (JP) 2021-169582

(51) Int. Cl. H05B 3/03; H05B 3/84

(52) U.S. Cl. CPC H05B 3/03; H05B 3/84; H05B 2203/003; H05B 2203/013

(57) ABSTRACT

A film heater includes a transparent conductive film, a first electrode, and a second electrode. The transparent conductive film includes a first heat generating portion, and a second heat generating portion. The first electrode includes a first connection portion, and a second connection portion. The first connection portion is connected to the first heat generating portion. The second connection portion is connected to the second heat generating portion and the first connection portion. The second electrode faces the first connection portion and is connected to the first heat generating portion and the second heat generating portion. Further, a length of a path of an electric current flowing through the second heat generating portion is shorter than a length of a path of an electric current flowing through the first heat generating portion. Also, an electrical resistance of the second connection portion is higher than that of the first connection portion.

### CROSS REFERENCE TO RELATED APPLICATION

The present application is a continuation application of International Patent Application No. PCT/JP2022/036687 filed on Sep. 30, 2022, which designated the U.S. and claims the benefit of priority from Japanese Patent Application No. 2021-169582 filed on Oct. 15, 2021. The entire disclosures of all of the above applications are incorporated herein by reference.

### TECHNICAL FIELD

The present disclosure relates to a film heater.

### BACKGROUND

Conventionally, a film heater is known that includes: an electrode having a connection portion, a bypass part and a taking-out part; and a transparent conductive film. In the film heater, an electric current flows from a power supply part to the transparent conductive film via the taking-out part, the bypass part, the connection portion, and a port. In this case, local heat generation may occur at the connecting portion.

### SUMMARY

According to an aspect of the present disclosure, a film heater includes: a transparent conductive film, a first electrode, and a second electrode. The transparent conductive film includes a first heat generating portion configured to generate heat when energized and to transmit light therethrough, and a second heat generating portion configured to generate heat when energized and to transmit light therethrough. The first electrode includes a first connection portion connected to the first heat generating portion, and a second connection portion connected to the second heat generating portion and the first connection portion. The second electrode faces the first connection portion and is connected to the first heat generating portion and the second heat generating portion. In the film heater, a length of a path of an electric current flowing through the second heat generating portion is shorter than a length of a path of an electric current flowing through the first heat generating portion, and an electrical resistance of the second connection portion is higher than the electrical resistance of the first connection portion.

### BRIEF DESCRIPTION OF THE DRAWINGS

Objects, features, and advantages of the present disclosure will become more apparent from the following detailed description made with reference to the accompanying drawings, in which:

FIG. 1 is a configuration diagram of a film heater according to a first embodiment;

FIG. 2 is an enlarged view of part II in FIG. 1;

FIG. 3 is a cross-sectional view taken along a line III-III in FIG. 2;

FIG. 4 is an enlarged view of part IV in FIG. 1;

FIG. 5 is an enlarged view of part V in FIG. 1;

FIG. 6 is an enlarged view of part VI in FIG. 1;

FIG. 7 is a cross-sectional view of a film heater according to a second embodiment;

FIG. 8 is a configuration diagram of a film heater according to a third embodiment;

FIG. 9 is a configuration diagram of a film heater according to a fourth embodiment;

FIG. 10 is a configuration diagram of a film heater according to a fifth embodiment;

FIG. 11 is a configuration diagram of a film heater according to a sixth embodiment; and

FIG. 12 is a configuration diagram of a film heater according to a seventh embodiment.

### DESCRIPTION OF EMBODIMENTS

A film heater may include: an electrode having a connection portion, a bypass part, and a taking-out part; and a transparent conductive film having a non-rectangular shape. The connection portion may be connected to the transparent conductive film so that an electric current flows between the connection portion and an inside of a heat generating portion of the transparent conductive film through a port. The bypass part may be connected to the connection portion and may be also connected to a power supply part via the taking-out part. In this case, an electric current flows from the power supply part to the transparent conductive film via the taking-out part, the bypass part, the connection portion, and the port.

The size of the connection portion of the film heater may be made smaller than the bypass part and the taking-out part. In this case, a power density of the connection portion becomes greater than a power density of the bypass part and a power density of the taking-out part, thereby an amount of heat generated per unit area of the connection portion becomes greater than an amount of heat generated per unit area of the bypass part and the taking-out part. Thus, local heat generation may occur at the connection portion.

It is an object of the present disclosure to provide a film heater that suppresses local heat generation in a transparent conductive film.

According to an aspect of the present disclosure, a film heater includes: a transparent conductive film, a first electrode, and a second electrode. The transparent conductive film includes a first heat generating portion configured to generate heat when energized and to transmit light therethrough, and a second heat generating portion configured to generate heat when energized and to transmit light therethrough. The first electrode includes a first connection portion connected to the first heat generating portion, and a second connection portion connected to the second heat generating portion and the first connection portion. The second electrode faces the first connection portion and is connected to the first heat generating portion and the second heat generating portion. In the film heater, a length of a path of an electric current flowing through the second heat generating portion is shorter than a length of a path of an electric current flowing through the first heat generating portion, and an electrical resistance of the second connection portion is higher than the electrical resistance of the first connection portion.

When the length of the path of the electric current flowing through the second heat generating portion is shorter than the length of the path of the electric current flowing through the first heat generating portion, a voltage applied to the second heat generating portion becomes lower than a voltage applied to the first heat generating portion. Therefore, a power density of the first heat generating portion and a power density of the second heat generating portion can be made equal, and thereby local heat generation of the transparent conductive film can be suppressed.

Hereinafter, embodiments will be described with reference to the drawings. In the following embodiments, the same or equivalent parts are denoted by the same reference numerals, and the description thereof will be omitted.

### First Embodiment

A film heater 10 of the present embodiment is attached to a camera, radar device, LIDAR, headlight, and glass mounted on a vehicle (not shown). Further, the film heater 10 performs ice melting, snow melting, and defogging of these objects by generating heat. Note that LIDAR is an abbreviation for Light Detection and Ranging/Laser Imaging Detection and Ranging.

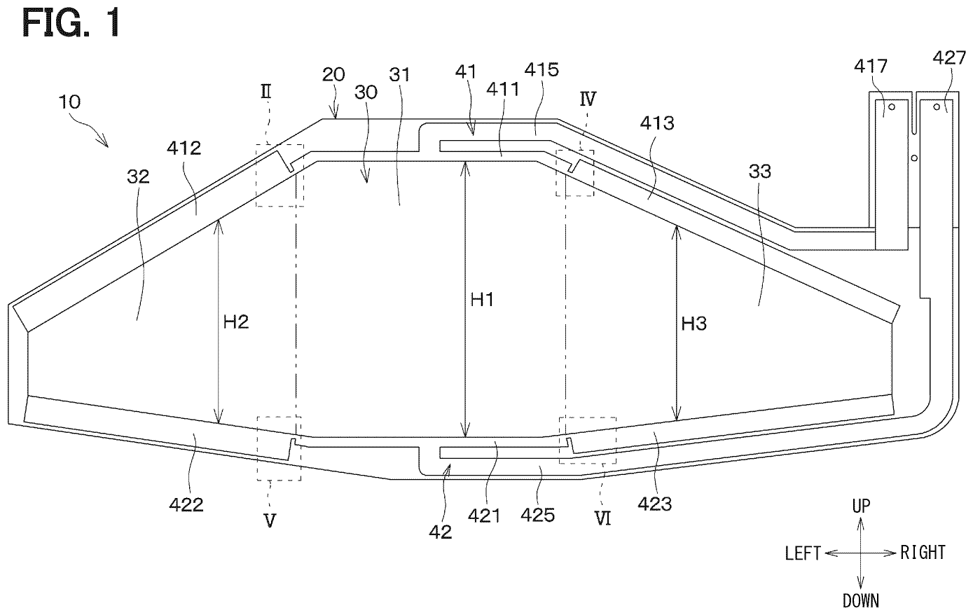

Specifically, the film heater 10 includes a transparent insulator 20, a transparent conductive film 30, a first electrode 41, and a second electrode 42, as shown in FIGS. 1 to 6. Here, in order to make the explanation of the configuration of the film heater 10 easy to understand, an upper side of the paper on which the figure is drawn is simply referred to as an upper side. A lower side of the paper on which the figure is drawn is simply referred to as a lower side. A left side of the paper on which the figure is drawn is simply referred to as a left side. A right side of the paper on which the figure is drawn is simply referred to as a right side.

The transparent insulator 20 is made of resin such as polycarbonate and has electrical insulation properties.

The transparent conductive film 30 is made of ITO, carbon nanotubes, or the like, so that it is transparent and has electrical conductivity. Note that ITO is an abbreviation for Indium Tin Oxide.

Further, the transparent conductive film 30 is formed into a planar shape and is covered with the transparent insulator 20. Further, the transparent conductive film 30 has a first heat generating portion 31, a second heat generating portion 32, and a third heat generating portion 33.

The first heat generating portion 31, the second heat generating portion 32, and the third heat generating portion 33 generate heat when an electric current flows through each of them (i.e., when energized, hereinafter). The first heat generating portion 31 is a central portion of the transparent conductive film 30. Further, the second heat generating portion 32 is connected to the left side of the first heat generating portion 31. Further, the third heat generating portion 33 is connected to the right side of the first heat generating portion 31.

Here, the length of a path of an electric current flowing through the first heat generating portion 31 is defined as a first current conduction distance H1. Further, the length of the path of the electric current flowing through the second heat generating portion 32 is defined as a second current conduction distance H2. In addition, the length of the path of the electric current flowing through the third heat generating portion 33 is defined as a third current conduction distance H3. The second current conduction distance H2 and the third current conduction distance H3 are respectively shorter than the first current conduction distance H1. Further, the second current conduction distance H2 becomes shorter toward the left from a boundary between the first heat generating portion 31 and the second heat generating portion 32. Furthermore, the third current conduction distance H3 becomes shorter toward the right from a boundary between the first heat generating portion 31 and the third heat generating portion 33. Further, the lengths of the first heat generating portion 31, the second heat generating portion 32, and the third heat generating portion 33 in a left-right direction are approximately the same. Note that, in the drawing, the boundary between the first heat generating portion 31 and the second heat generating portion 32, and the boundary between the first heat generating portion 31 and the third heat generating portion 33 are schematically shown by a two-dot chain line. Further, the first current conduction distance H1 is the same as the length of the first heat generating portion 31 in a vertical direction (i.e., an up-down direction). The second current conduction distance H2 is the same as the length of the second heat generating portion 32 in the vertical direction. The third current conduction distance H3 is the same as the length of the third heat generating portion 33 in the vertical direction.

The first electrode 41 is made of metal such as gold, platinum, silver, copper, or aluminum. Further, the first electrode 41 is a positive electrode. Furthermore, the first electrode 41 has a first connection portion 411, a second connection portion 412, a third connection portion 413, a first lead portion 415, and a first terminal portion 417.

The first connection portion 411 is connected to the upper side of the first heat generating portion 31 and extends in the left-right direction.

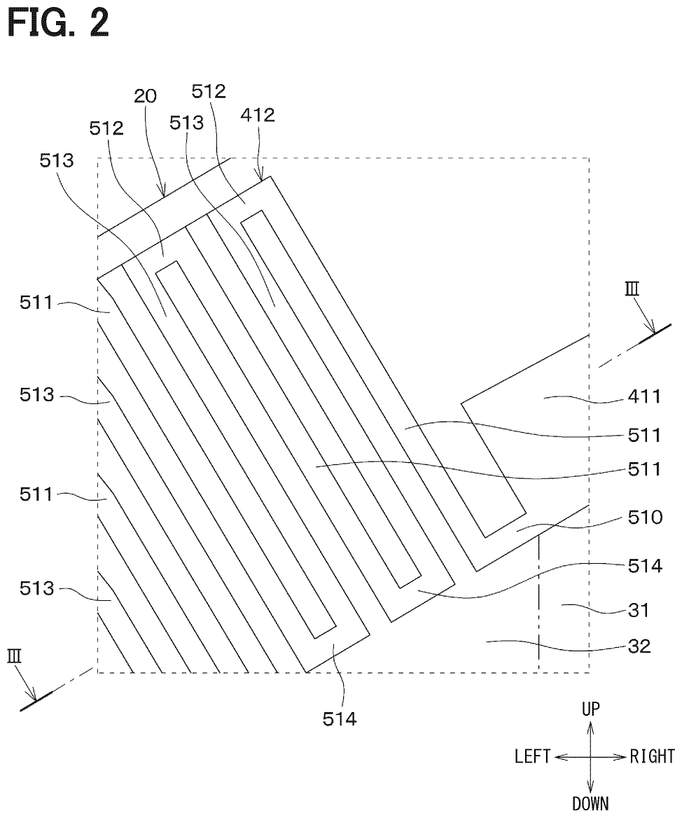

The second connection portion 412 is connected to an upper side of the second heat generating portion 32. Further, as shown in FIG. 2, the second connection portion 412 includes a first end portion 510, a plurality of first extension portions 511, a plurality of second extension portions 512, a plurality of third extension portions 513, and a plurality of fourth extension portions 514.

The first end portion 510 is connected to a left side of the first connection portion 411, and extends in a lower left direction from the boundary between the first end portion 510 and the first connection portion 411. A right-most first extension portion 511 among the plurality of first extension portions 511 is connected to the left side of the first end portion 510. Further, the first extension portion 511 extends in an upper left direction. The second extension portion 512 is connected to an upper side of the first extension portion 511, and extends in a lower left direction from the boundary between the second extension portion 512 and the first extension portion 511. The third extension portion 513 is connected to a left side of the second extension portion 512, and extends in a lower right direction from the boundary between the third extension portion 513 and the second extension portion 512. The fourth extension portion 514 is connected to a lower side of the third extension portion 513 and a lower side of the first extension portion 511, and extends in a lower left direction from the boundary between the fourth extension portion 514 and the third extension portion 513. Therefore, the second connection portion 412 has a meandering shape due to the first end portion 510, the first extension portion 511, the second extension portion 512, the third extension portion 513, and the fourth extension portion 514 described above. Further, due to the configuration described above, a total length of the second connection portion 412 is longer than a total length of the first connection portion 411. The first end portion 510, the first extension portion 511, the second extension portion 512, the third extension portion 513, and the fourth extension portion 514 may extend in directions that intersect with each other.

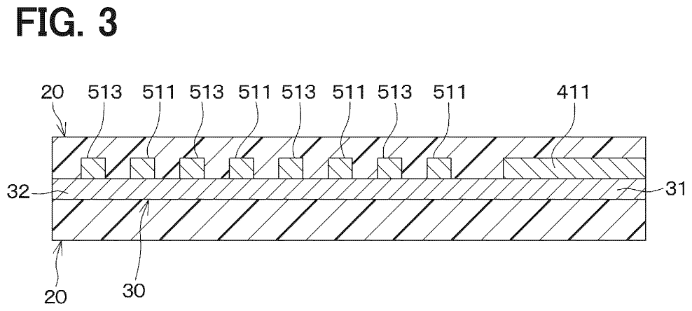

Further, each of the widths of the first end portion 510, the first extension portion 511, the second extension portion 512, the third extension portion 513, and the fourth extension portion 514 is smaller than the width of the first connection portion 411. Furthermore, as shown in FIG. 3, thicknesses of the first end portion 510, the first extension portion 511, the second extension portion 512, the third extension portion 513, and the fourth extension portion 514 is the same as thickness of the first connection portion 411. Further, since the second connection portion 412 is formed of a same material as the first connection portion 411, the electrical conductivity of the second connection portion 412 is the same as that of the first connection portion 411.

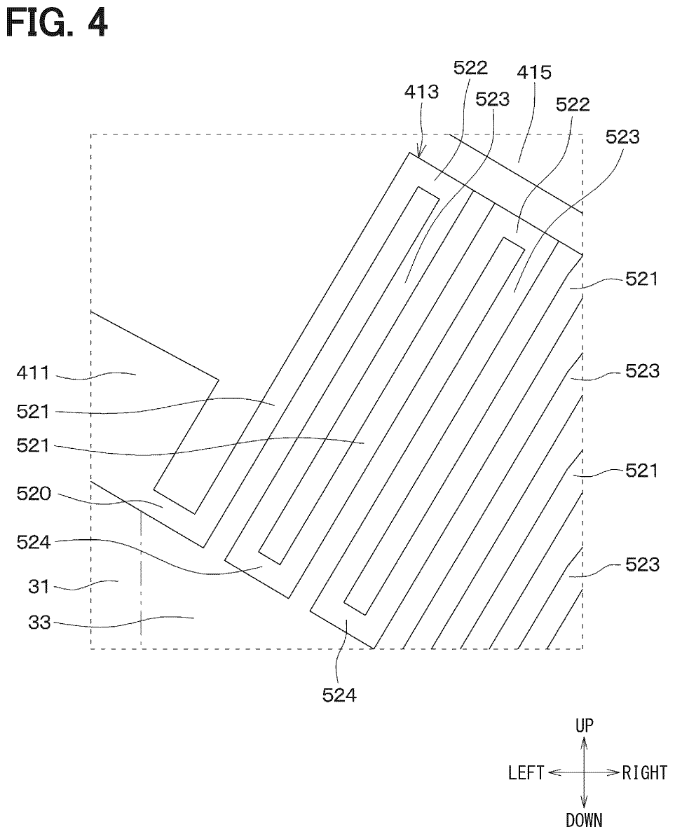

The third connection portion 413 is connected to an upper side of the third heat generating portion 33. Further, as shown in FIG. 4, the third connection portion 413 includes a second end portion 520, a plurality of fifth extension portions 521, a plurality of sixth extension portions 522, a plurality of seventh extension portions 523, and a plurality of eighth extension portions 524.

The second end portion 520 is connected to a right side of the first connection portion 411, and extends from the boundary between the second end portion 520 and the first connection portion 411 in a lower right direction. The left-most fifth extension portion 521 among the plurality of fifth extension portions 521 is connected to a right side of the second end portion 520. Further, the fifth extension portion 521 extends in an upper right direction. The sixth extension portion 522 is connected to an upper side of the fifth extension portion 521, and extends in a lower right direction from the boundary between the sixth extension portion 522 and the fifth extension portion 521. The seventh extension portion 523 is connected to a right side of the sixth extension portion 522, and extends in a lower left direction from the boundary between the seventh extension portion 523 and the sixth extension portion 522. The eighth extension portion 524 is connected to a lower side of the seventh extension portion 523 and a lower side of the fifth extension portion 521, and extends in a lower right direction from the boundary between the eighth extension portion 524 and the seventh extension portion 523. Therefore, the third connection portion 413 has a meandering shape due to the second end portion 520, the fifth extension portion 521, the sixth extension portion 522, the seventh extension portion 523, and the eighth extension portion 524. Further, due to the above configuration, a total length of the third connection portion 413 is longer than the total length of the first connection portion 411. Note that the second end portion 520, the fifth extension portion 521, the sixth extension portion 522, the seventh extension portion 523, and the eighth extension portion 524 may extend in directions that intersect with each other.

Further, each of the widths of the second end portion 520, the fifth extension portion 521, the sixth extension portion 522, the seventh extension portion 523, and the eighth extension portion 524 is smaller than the width of the first connection portion 411. Further, the thicknesses of the second end portion 520, the fifth extension portion 521, the sixth extension portion 522, the seventh extension portion 523, and the eighth extension portion 524 are the same as the thickness of the first connection portion 411. Further, since the third connection portion 413 is formed of the same material as the first connection portion 411, the electrical conductivity of the third connection portion 413 is the same as that of the first connection portion 411.

The first lead portion 415 is connected to the first connection portion 411, and extends along an edge of the transparent insulator 20. The first terminal portion 417 is connected to the first lead portion 415 and a power source (not shown).

The second electrode 42 is made of metal such as gold, platinum, silver, copper, aluminum or the like. Further, the second electrode 42 is a negative electrode. Further, returning to FIG. 1, the second electrode 42 includes a fourth connection portion 421, a fifth connection portion 422, a sixth connection portion 423, a second lead portion 425, and a second terminal portion 427.

The fourth connection portion 421 is connected to a lower side of the first heat generating portion 31, and extends in a left-right direction.

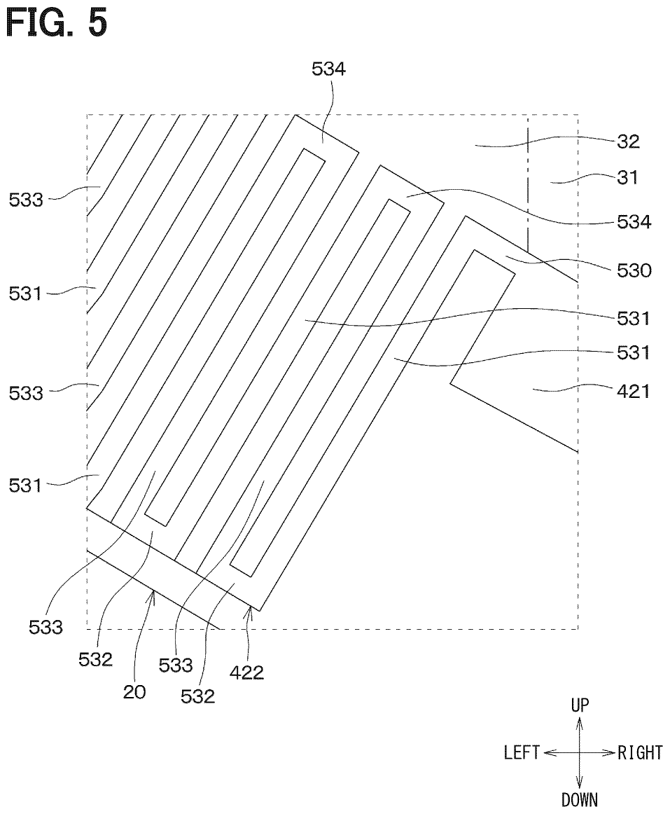

The fifth connection portion 422 is connected to the lower side of the second heat generating portion 32. Further, as shown in FIG. 5, the fifth connection portion 422 includes a third end portion 530, a plurality of ninth extension portions 531, a plurality of tenth extension portions 532, a plurality of eleventh extension portions 533, and a plurality of twelfth extension portions 534.

The third end portion 530 is connected to a left side of the fourth connection portion 421, and extends in an upper left direction from the boundary between the third end portion 530 and the fourth connection portion 421. A right-most ninth extension portion 531 among the plurality of ninth extension portions 531 is connected to a left side of the third end portion 530. Further, the ninth extension portion 531 extends in a lower left direction. The tenth extension portion 532 is connected to a lower side of the ninth extension portion 531, and extends in an upper left direction from the boundary between the tenth extension portion 532 and the ninth extension portion 531. The eleventh extension portion 533 is connected to a left side of the tenth extension portion 532, and extends in an upper right direction from the boundary between the eleventh extension portion 533 and the tenth extension portion 532. The twelfth extension portion 534 is connected to an upper side of the eleventh extension portion 533 and an upper side of the ninth extension portion 531, and extends in an upper left direction from the boundary between the twelfth extension portion 534 and the eleventh extension portion 533. Therefore, the fifth connection portion 422 has a meandering shape due to the third end portion 530, the ninth extension portion 531, the tenth extension portion 532, the eleventh extension portion 533, and the twelfth extension portion 534. Further, due to the configuration described above, a total length of the fifth connection portion 422 is longer than a total length of the fourth connection portion 421.

Further, the widths of the third end portion 530, the ninth extension portion 531, the tenth extension portion 532, the eleventh extension portion 533, and the twelfth extension portion 534 are smaller than the width of the fourth connection portion 421. Furthermore, the thicknesses of the third end portion 530, the ninth extension portion 531, the tenth extension portion 532, the eleventh extension portion 533, and the twelfth extension portion 534 are the same as the thickness of the fourth connection portion 421. Further, since the fifth connection portion 422 is formed of the same material as the fourth connection portion 421, the electrical conductivity of the fifth connection portion 422 is the same as that of the fourth connection portion 421.

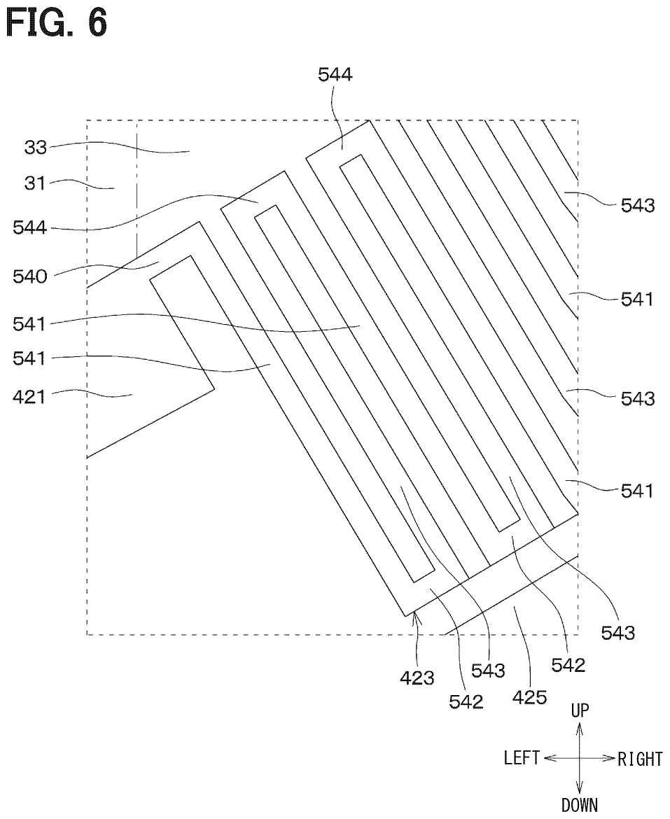

The sixth connection portion 423 is connected to a lower side of the third heat generating portion 33 and to a right side of the fourth connection portion 421. Further, as shown in FIG. 6, the sixth connection portion 423 includes a fourth end portion 540, a plurality of thirteenth extension portions 541, a plurality of fourteenth extension portions 542, a plurality of fifteenth extension portions 543, and a plurality of sixteenth extension portions 544.

The fourth end portion 540 is connected to the right side of the fourth connection portion 421, and extends in an upper right direction from the boundary between the fourth end portion 540 and the fourth connection portion 421. A left-most thirteenth extension portion 541 among the plurality of thirteenth extension portions 541 is connected to a right side of the fourth end portion 540. Further, the thirteenth extension portion 541 extends in a lower right direction. The fourteenth extension portion 542 is connected to a lower side of the thirteenth extension portion 541, and extends in an upper right direction from the boundary between the fourteenth extension portion 542 and the thirteenth extension portion 541. The fifteenth extension portion 543 is connected to a right side of the fourteenth extension portion 542, and extends in an upper left direction from the boundary between the fifteenth extension portion 543 and the fourteenth extension portion 542. The sixteenth extension portion 544 is connected to an upper side of the fifteenth extension portion 543 and an upper side of the thirteenth extension portion 541, and extends in an upper right direction from the boundary between the sixteenth extension portion 544 and the thirteenth extension portion 541. Therefore, the sixth connection portion 423 has a meandering shape due to the fourth end portion 540, the thirteenth extension portion 541, the fourteenth extension portion 542, the fifteenth extension portion 543, and the sixteenth extension portion 544. Further, due to the above configuration, a total length of the sixth connection portion 423 is longer than the total length of the fourth connection portion 421.

Further, the widths of the fourth end portion 540, the thirteenth extension portion 541, the fourteenth extension portion 542, the fifteenth extension portion 543, and the sixteenth extension portion 544 are smaller than the width of the fourth connection portion 421. Further, the thicknesses of the fourth end portion 540, the thirteenth extension portion 541, the fourteenth extension portion 542, the fifteenth extension portion 543, and the sixteenth extension portion 544 are the same as the thickness of the fourth connection portion 421. Further, since the sixth connection portion 423 is formed of the same material as the fourth connection portion 421, the electrical conductivity of the sixth connection portion 423 is the same as that of the fourth connection portion 421.

The second lead portion 425 is connected to the fourth connection portion 421, and extends along an edge of the transparent insulator 20. The second terminal portion 427 is connected to the second lead portion 425 and the power source (not shown).

The film heater 10 is configured as described above. Heat generated by the film heater 10 de-ices and defogs a camera, a radar device, a LIDAR, a headlight, and a glass mounted on a vehicle (not shown), and also suppresses local heat generation in the transparent conductive film 30. Next, heat generation by the film heater 10 will be explained.

Here, the first electrode 41 is a positive electrode, and the second electrode 42 is a negative electrode. Therefore, when a power source (not shown) supplies electric power to the film heater 10, an electric current flows from the power source (not shown) to the first connection portion 411 via the first terminal portion 417 and the first lead portion 415. In addition, an electric current flows from the first connection portion 411 to the fourth connection portion 421 via the first heat generating portion 31. In such manner, the first heat generating portion 31 generates heat.

Further, an electric current flows from the first connection portion 411 to the second connection portion 412. Further, an electric current flows from the second connection portion 412 to the fourth connection portion 421 via the second heat generating portion 32 and the fifth connection portion 422. Therefore, the second heat generating portion 32 generates heat.

Here, since the total length of the second connection portion 412 is longer than the total length of the first connection portion 411 and the width of the second connection portion 412 is smaller than the width of the first connection portion 411, the electrical resistance of the second connection portion 412 is greater than the electrical resistance of the first connection portion 411. Therefore, a voltage drop at the second connection portion 412 when an electric current flows from the second connection portion 412 to the second heat generating portion 32 is greater than when the electrical resistance of the second connection portion 412 is less than or equal to the electrical resistance of the first connection portion 411. Further, since the total length of the fifth connection portion 422 is longer than the total length of the fourth connection portion 421 and the width of the fifth connection portion 422 is smaller than the width of the fourth connection portion 421, the electrical resistance of the fifth connection portion 422 is greater than the electrical resistance of the fourth connection portion 421. Therefore, when an electric current flows from the second heat generating portion 32 to the fourth connection portion 421 via the fifth connection portion 422, a voltage drop at the fifth connection portion 422 is greater than when the electrical resistance of the fifth connection portion 422 is less than or equal to the electrical resistance of the fourth connection portion 421. Therefore, the voltage applied to the second heat generating portion 32 is lower than the voltage applied to the first heat generating portion 31. Thus, the amount of heat generated by the second heat generating portion 32 is lower than the amount of heat generated by the first heat generating portion 31. Accordingly, the amount of heat generated per unit area of the second heat generating portion 32 is the same as the amount of heat generated per unit area of the first heat generating portion 31.

Further, an electric current flows from the first connection portion 411 to the third connection portion 413. In addition, an electric current flows from the third connection portion 413 to the fourth connection portion 421 via the third heat generating portion 33 and the sixth connection portion 423. In such manner, the third heat generating portion 33 generates heat. Therefore, the first heat generating portion 31, the second heat generating portion 32, and the third heat generating portion 33 heat a camera, a radar device, a LIDAR, a headlight, and a glass mounted on the vehicle (not shown), thereby ice melting, snow melting and defogging are performed.

Here, since the total length of the third connection portion 413 is longer than the total length of the first connection portion 411 and the width of the third connection portion 413 is smaller than the width of the first connection portion 411, the electrical resistance of the third connection portion 413 is greater than the electrical resistance of the first connection portion 411. Therefore, a voltage drop at the third connection portion 413 when the electric current flows from the third connection portion 413 to the third heat generating portion 33 is greater than when the electrical resistance of the third connection portion 413 is less than or equal to the electrical resistance of the first connection portion 411. Further, since the total length of the sixth connection portion 423 is longer than the total length of the fourth connection portion 421, and the width of the sixth connection portion 423 is smaller than the width of the fourth connection portion 421, the electrical resistance of the sixth connection portion 423 is greater than the electrical resistance of the fourth connection portion 421. Therefore, when an electric current flows from the third heat generating portion 33 to the fourth connection portion 421 via the sixth connection portion 423, the voltage drop at the sixth connection portion 423 is greater than when the electrical resistance of the sixth connection portion 423 is less than or equal to the electrical resistance of the fourth connection portion 421. Therefore, a voltage applied to the third heat generating portion 33 is lower than a voltage applied to the first heat generating portion 31. Thus, the amount of heat generated by the third heat generating portion 33 is lower than the amount of heat generated by the first heat generating portion 31. As a result, the amount of heat generated per unit area of the third heat generating portion 33 is the same as the amount of heat generated per unit area of the first heat generating portion 31. Thus, the amount of heat generated per unit area is the same in each of the first heat generating portion 31, the second heat generating portion 32, and the third heat generating portion 33.

Further, the electric current flowing through the fourth connection portion 421 flows to a power source (not shown) via the second lead portion 425 and the second terminal portion 427.

As described above, the film heater 10 generates heat. Next, the suppression of local heat generation in the transparent conductive film 30 will be explained.

The film heater 10 includes the transparent conductive film 30, the first electrode 41, and the second electrode 42. The transparent conductive film 30 has the first heat generating portion 31 and the second heat generating portion 32. The first heat generating portion 31 generates heat when energized, and transmits light therethrough. The second heat generating portion 32 generates heat when energized, and transmits light therethrough. The first electrode 41 has the first connection portion 411 and the second connection portion 412. The first connection portion 411 is connected to the first heat generating portion 31. The second connection portion 412 is connected to the second heat generating portion 32 and the first connection portion 411. The second electrode 42 faces the first connection portion 411, and is connected to the first heat generating portion 31 and the second heat generating portion 32. Further, the transparent conductive film 30 is formed in a planar shape. Further, the second current conduction distance H2 is shorter than the first current conduction distance H1. Further, the electrical resistance of the second connection portion 412 is greater than the electrical resistance of the first connection portion 411. In such manner, when the electric current flows through the second connection portion 412 and the second heat generating portion 32 generates heat, the voltage drop at the second connection portion 412 is greater than when the electrical resistance of the second connection portion 412 is greater than the electrical resistance of the first connection portion 411. In such manner, the voltage applied to the second heat generating portion 32 becomes lower than the voltage applied to the first heat generating portion 31. Here, the first current conduction distance H1 corresponds to the length of the path of the electric current flowing through the first heat generating portion 31. The second current conduction distance H2 corresponds to the length of the path of the electric current flowing through the second heat generating portion 32. Further, the electrical resistance of the second connection portion 412 is greater than the electrical resistance of the first connection portion 411. On the other hand, the electrical resistance of the second connection portion 412 per unit length in a direction along which the electric current flows through the second connection portion 412 may be greater than the electrical resistance of the first connection portion 411 per unit length in a direction along which the electric current flows in the first connection portion 411.

Here, a power density Wρ, which is an electric power per unit area, is expressed as in the following equation (1). Here, V is a voltage. Rs is a sheet resistance of the transparent conductive film 30. Sheet resistance is an electrical resistance per unit area. H is a length of the transparent conductive film 30 in a direction parallel to a surface of the transparent conductive film 30 and from the first electrode 41 to the second electrode 42.

$$\begin{matrix}( Equation 1 ) & \\ W ρ = \frac{{V}^{2}}{R s \times {H}^{2}} & ( 1 )\end{matrix}$$

In the film heater 10, when the second current conduction distance H2 is shorter than the first current conduction distance H1, a voltage applied to the second heat generating portion 32 becomes lower than a voltage applied to the first heat generating portion 31. Therefore, since the power density Wρ of the first heat generating portion 31 and the power density Wρ of the second heat generating portion 32 become the same, local heat generation of the transparent conductive film 30 is suppressed. Further, since local heat generation in the transparent conductive film 30 is suppressed, energy consumed by local heat generation is suppressed. Therefore, there is no need to supply extra electric power from the power source to the film heater 10, thereby the power consumption of the film heater 10 is suppressed.

Moreover, the film heater 10 also achieves the effects described below.

[1-1] The film heater 10 includes the transparent conductive film 30, the first electrode 41, and the second electrode 42. The transparent conductive film 30 has the first heat generating portion 31 and the second heat generating portion 32, as described above. The first electrode 41 is connected to the upper side of the transparent conductive film 30. The second electrode 42 has the fourth connection portion 421 and the fifth connection portion 422. The fourth connection portion 421 is connected to one side of the first heat generating portion 31 opposite to the first electrode 41. The fifth connection portion 422 is connected to the second heat generating portion 32 and the fourth connection portion 421. The electrical resistance of the fifth connection portion 422 is greater than the electrical resistance of the fourth connection portion 421. In such manner, when an electric current flows through the fifth connection portion 422 and the second heat generating portion 32 generates heat, the voltage drop at the fifth connection portion 422 is greater than the one when the electrical resistance of the fifth connection portion 422 is less than or equal to the electrical resistance of the fourth connection portion 421. In such manner, the voltage applied to the second heat generating portion 32 becomes lower than the voltage applied to the first heat generating portion 31. Note that in such case, the first electrode 41 corresponds to a second electrode. The second electrode 42 corresponds to a first electrode. The fourth connection portion 421 corresponds to a first connection portion. The fifth connection portion 422 corresponds to a second connection portion. Further, the electrical resistance of the fifth connection portion 422 is greater than the electrical resistance of the fourth connection portion 421. On the other hand, the electrical resistance of the fifth connection portion 422 per unit length in a direction along which the electric current flows through the fifth connection portion 422 may be greater than the electrical resistance of the fourth connection portion 421 per unit length in a direction along which the electric current flows through the fourth connection portion 421.

Thereby, when the second current conduction distance H2 is shorter than the first current conduction distance H1, the voltage applied to the second heat generating portion 32 becomes lower than the voltage applied to the first heat generating portion 31. Since the power density Wρ of the first heat generating portion 31 and the power density Wρ of the second heat generating portion 32 become the same, local heat generation of the transparent conductive film 30 is suppressed. Further, since local heat generation in the transparent conductive film 30 is suppressed, energy consumed by local heat generation is suppressed. Therefore, there is no need to supply extra electric power from the power source to the film heater 10, thereby the power consumption of the film heater 10 is suppressed.

[1-2] The length of the path of the electric current flowing through the second connection portion 412 is longer than the length of the path of the electric current flowing through the first connection portion 411. In such manner, the electrical resistance of the second connection portion 412 tends to be greater than the electrical resistance of the first connection portion 411.

[1-3] The width of the second connection portion 412 is smaller than the width of the first connection portion 411. In such manner, the electrical resistance of the second connection portion 412 tends to be greater than the electrical resistance of the first connection portion 411. Note that the width of the first connection portion 411 corresponds to the width (a) in a direction perpendicular to the direction of the electric current flowing through the first connection portion 411 and (b) in a direction along which the surface of the transparent conductive film 30 extends. The width of the second connection portion 412 corresponds to the width (c) in a direction perpendicular to the direction of the current flowing through the second connection portion 412 and (d) in a direction along which the surface of the transparent conductive film 30 extends.

[1-4] The first electrode 41 further includes the first lead portion 415 and the first terminal portion 417. The first lead portion 415 is connected to the first connection portion 411. The first terminal portion 417 is connected to the first lead portion 415 and a power source (not shown). Further, the electrical resistance of the first connection portion 411 is lower than the electrical resistance of the second connection portion 412. In such manner, compared to a case where the first lead portion 415 is connected to the second connection portion 412, it is easier for the electric current to flow from the power source to the heat generating portion 31 through the first terminal portion 417, the first lead portion 415, and the first connection portion 411. Therefore, the first heat generating portion 31 easily generates heat. Note that the first lead portion 415 and the first terminal portion 417 correspond to a lead portion.

[1-5] The second electrode 42 further includes the second lead portion 425 and the second terminal portion 427. The second lead portion 425 is connected to the fourth connection portion 421. The second terminal portion 427 is connected to the second lead portion 425 and a power source (not shown). The fourth connection portion 421 is connected to a lower side of the first heat generating portion 31. Further, the electrical resistance of the fourth connection portion 421 is lower than the electrical resistance of the fifth connection portion 422. In such manner, compared to a case where the second lead portion 425 is connected to the fifth connection portion 422, it is easier for the electric current flowing through the first heat generating portion 31 to further flow to the power source, through the fourth connection portion 421, the second lead portion 425 and the second terminal portion 427. Therefore, the first heat generating portion 31 easily generates heat. Note that the second lead portion 425 and the second terminal portion 427 correspond to a lead portion.

### Second Embodiment

In the second embodiment, the forms of a first connection portion 411, a second connection portion 412, a third connection portion 413, a fourth connection portion 421, a fifth connection portion 422, and a sixth connection portion 423 are different. The other configurations are the same as those of the first embodiment.

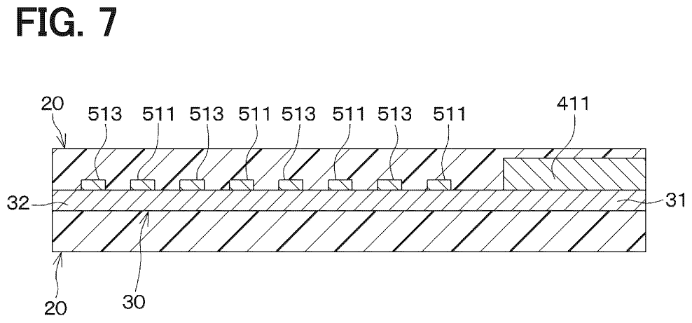

The first extension portion 511 and the third extension portion 513 of the second connection portion 412 are thinner in thickness than the first connection portion 411, as shown in FIG. 7. Similarly, the first end portion 510, the second extension portion 512, and the fourth extension portion 514 of the second connection portion 412 are thinner in thickness than the first connection portion 411.

Further, the second end portion 520, the fifth extension portion 521, the sixth extension portion 522, the seventh extension portion 523, and the eighth extension portion 524 of the third connection portion 413 are thinner in thickness than the first connection portion 411.

Further, the third end portion 530, the ninth extension portion 531, the tenth extension portion 532, the eleventh extension portion 533, and the twelfth extension portion 534 of the fifth connection portion 422 are thinner in thickness than the fourth connection portion 421.

Further, the fourth end portion 540, the thirteenth extension portion 541, the fourteenth extension portion 542, the fifteenth extension portion 543, and the sixteenth extension portion 544 of the sixth connection portion 423 are thinner in thickness than the fourth connection portion 421.

Further, the first connection portion 411, the second connection portion 412, the third connection portion 413, the fourth connection portion 421, the fifth connection portion 422, and the sixth connection portion 423 are formed by sintering metal such as gold, platinum, silver, copper, aluminum, or the like. Further, the second connection portion 412 and the third connection portion 413 are formed by being sintered at lower temperature than the first connection portion 411. Therefore, the porosity of the second connection portion 412 and the third connection portion 413 is greater than that of the first connection portion 411, thereby the electrical conductivity of the second connection portion 412 and the third connection portion 413 is lower than that of the first connection portion 411. Further, the fifth connection portion 422 and the sixth connection portion 423 are formed by being sintered at lower temperature than the fourth connection portion 421. Therefore, the porosity of the fifth connection portion 422 and the sixth connection portion 423 is greater than that of the fourth connection portion 421, thereby the electrical conductivity of the fifth connection portion 422 and the sixth connection portion 423 is lower than that of the fourth connection portion 421. Note that, since the first connection portion 411 is made of silver and the second connection portion 412 and the third connection portion 413 are made of aluminum, the electrical conductivity of the second connection portion 412 and the third connection portion 413 may be lower than the electrical conductivity of the first connection portion 411. In such manner, since the first connection portion 411, the second connection portion 412, and the third connection portion 413 are formed of different materials, the electrical conductivity of the second connection portion 412 and the third connection portion 413 may be lower than the electrical conductivity of the first connection portion 411. Further, since the fourth connection portion 421 is made of silver and the fifth connection portion 422 and the sixth connection portion 423 are made of aluminum, the electrical conductivity of the fifth connection portion 422 and the sixth connection portion 423 may be lower than the electrical conductivity of the fourth connection portion 421. As described above, since the fourth connection portion 421, the fifth connection portion 422, and the sixth connection portion 423 are formed of different materials, the electrical conductivity of the fifth connection portion 422 and the sixth connection portion 423 may be lower than the electrical conductivity of the fourth connection portion 421.

The second embodiment is configured in the above-described manner. The second embodiment also achieves the same effects as the first embodiment. The second embodiment also achieves the following effects.

[2-1] The thickness of the second connection portion 412 in the direction perpendicular to (a) the direction of the electric current flowing through the second connection portion 412 and (b) the surface of the transparent conductive film 30 is the same as the thickness thereof in the direction perpendicular to (c) the direction of the electric current flowing through the first connection portion 411 and (d) the surface of the transparent conductive film 30. In such manner, the electrical resistance of the second connection portion 412 tends to be greater than the electrical resistance of the first connection portion 411.

[2-2] The electrical conductivity of the second connection portion 412 is lower than the electrical conductivity of the first connection portion 411. In such manner, the electrical resistance of the second connection portion 412 tends to be greater than the electrical resistance of the first connection portion 411.

[2-3] The thickness of the fifth connection portion 422 in the direction perpendicular to (a) the direction of the electric current flowing through the fifth connection portion 422 and (b) the surface of the transparent conductive film 30 is smaller than the thickness in the direction perpendicular to (c) the direction of the electric current flowing through the fourth connection portion 421 and (d) the surface of the transparent conductive film 30. Thereby, the electrical resistance of the fifth connection portion 422 tends to be greater than the electrical resistance of the fourth connection portion 421.

[2-4] The electrical conductivity of the fifth connection portion 422 is lower than the electrical conductivity of the fourth connection portion 421. Thereby, the electrical resistance of the fifth connection portion 422 tends to be greater than the electrical resistance of the fourth connection portion 421.

### Third Embodiment

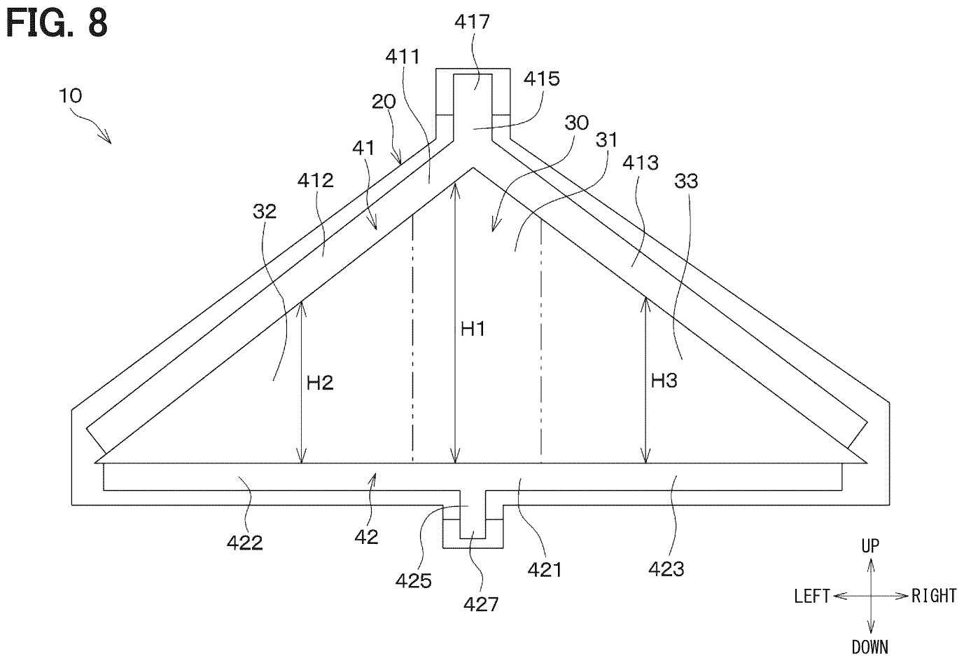

In the third embodiment, the form of a transparent conductive film 30 is different. The other configurations are the same as those of the first embodiment. The transparent conductive film 30 is formed in a triangular shape, as shown in FIG. 8. Therefore, the first heat generating portion 31 of the transparent conductive film 30 is formed, for example, in a pentagonal shape. Further, the second heat generating portion 32 and the third heat generating portion 33 of the transparent conductive film 30 are formed, for example, in a triangular shape.

The third embodiment is configured as described above and achieves the same and corresponding effects as the first embodiment.

### Fourth Embodiment

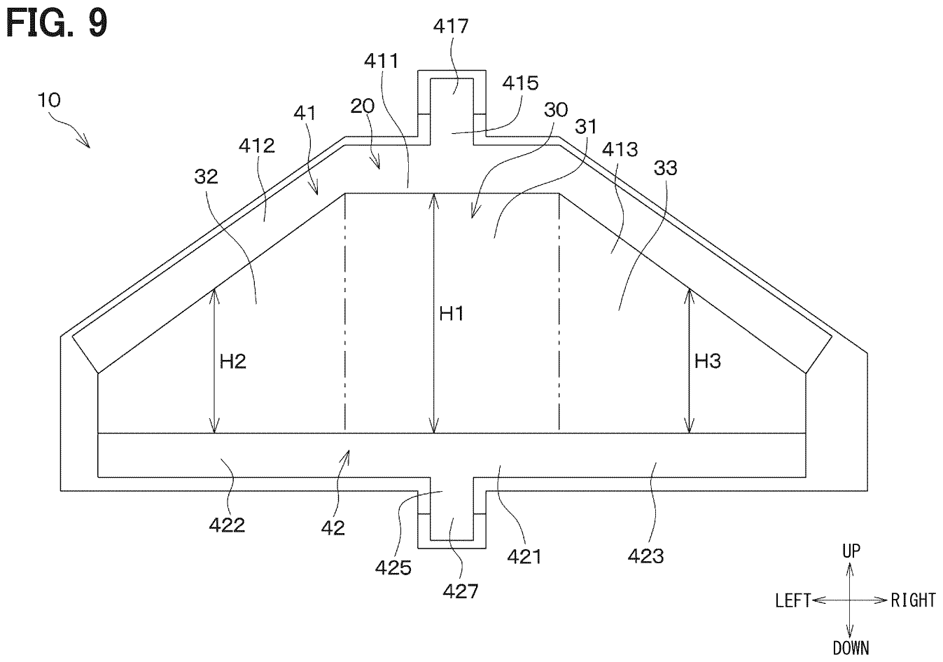

In the fourth embodiment, the form of a transparent conductive film 30 is different. The other configurations are the same as those of the first embodiment. The transparent conductive film 30 is formed in a hexagonal shape, as shown in FIG. 9. Therefore, the first heat generating portion 31 is formed, for example, in a rectangular shape. Further, the second heat generating portion 32 and the third heat generating portion 33 are formed, for example, in a trapezoidal shape.

The fourth embodiment is configured as described above and achieves the same and corresponding effects as the first embodiment.

### Fifth Embodiment

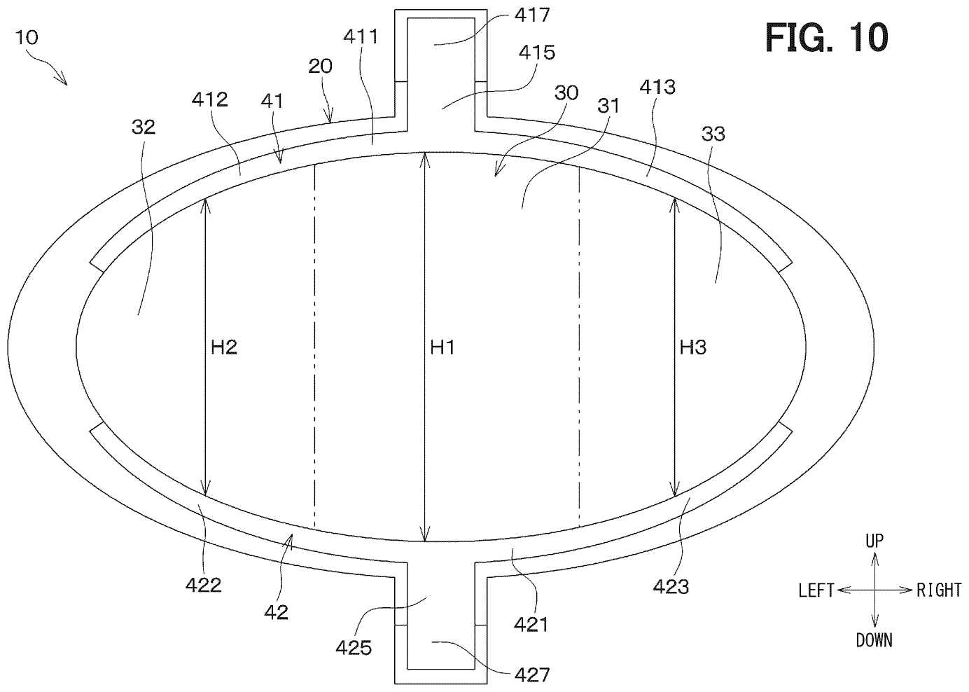

In the fifth embodiment, the form of a transparent conductive film 30 is different. The other configurations are the same as those of the first embodiment. The transparent conductive film 30 is formed in an elliptical shape, as shown in FIG. 10. Note that the transparent conductive film 30 may be formed in a perfect circular shape.

The fifth embodiment is configured as described above and achieves the same and corresponding effects as the first embodiment.

### Sixth Embodiment

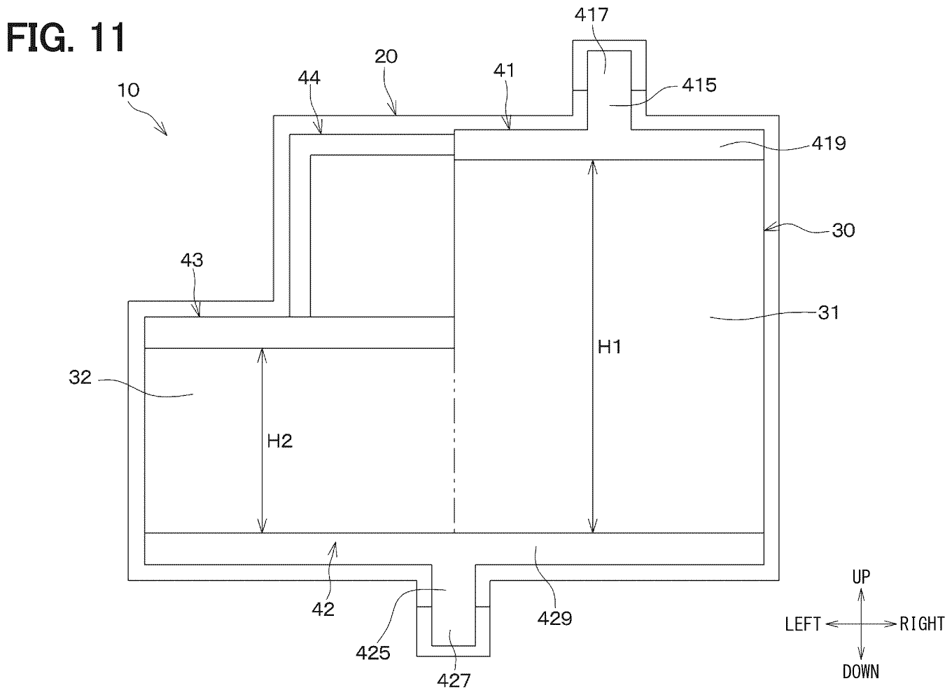

In the sixth embodiment, the form of the film heater 10 is different. A film heater 10 includes a transparent insulator 20, a transparent conductive film 30, a first electrode 41, a second electrode 42, a third electrode 43, and a fourth electrode 44, as shown in FIG. 11.

The transparent insulator 20 is formed similarly to the first embodiment. The transparent conductive film 30 has a first heat generating portion 31 and a second heat generating portion 32. The first heat generating portion 31 and the second heat generating portion 32 are formed in a rectangular shape. A left side of the first heat generating portion 31 is connected to a right side of the second heat generating portion 32. Further, a second current conduction distance H2 is shorter than a first current conduction distance H1. Further, the lengths of the first heat generating portion 31 and the second heat generating portion 32 in a left-right direction are approximately the same.

The first electrode 41 is made of metal such as gold, platinum, silver, copper, or the like, as in the first embodiment. Further, the first electrode 41 is a positive electrode. Further, the first electrode 41 includes a first electrode connection portion 419, a first lead portion 415, and a first terminal portion 417. The first electrode connection portion 419 is connected to an upper side of the first heat generating portion 31. The first lead portion 415 is connected to the first electrode connection portion 419. The first terminal portion 417 is connected to the first lead portion 415 and a power source (not shown).

The second electrode 42 is made of metal such as gold, platinum, silver, copper, or the like, as in the first embodiment. Further, the second electrode 42 is a negative electrode. Further, the second electrode 42 includes a second electrode connection portion 429, a second lead portion 425, and a second terminal portion 427. The second electrode connection portion 429 is connected to a lower side of the first heat generating portion 31 and the second heat generating portion 32. The second lead portion 425 is connected to the second electrode connection portion 429. The second terminal portion 427 is connected to the second electrode connection portion 429 of the second lead portion 425 and the power source (not shown).

The third electrode 43 is made of metal such as gold, platinum, silver, copper or the like. Further, the third electrode 43 is connected to an upper side of the second heat generating portion 32. The fourth electrode 44 is made of metal such as gold, platinum, silver, copper or the like. Further, the fourth electrode 44 is connected to the first electrode connection portion 419 and the third electrode 43. Further, a cross-sectional area of the fourth electrode 44 is smaller than cross-sectional areas of the first electrode 41, the second electrode 42, and the third electrode 43 in a direction perpendicular to a direction in which the electric current flows. Further, cross-sectional areas of the first electrode 41, the second electrode 42, and the third electrode 43 are the same in a direction perpendicular to a direction in which the electric current flows.

The sixth embodiment is configured as described above. Next, heat generation by the film heater 10 will be explained.

Here, the first electrode 41 is a positive electrode, and the second electrode 42 is a negative electrode. Therefore, when a power source (not shown) supplies electric power to the film heater 10, an electric current flows from the power source (not shown) to the first electrode connection portion 419 via the first terminal portion 417 and the first lead portion 415. Further, an electric current flows from the first electrode connection portion 419 to the second electrode connection portion 429 via the first heat generating portion 31. In such manner, the first heat generating portion 31 generates heat.

Further, an electric current flows from the first electrode connection portion 419 to the second electrode connection portion 429 via the fourth electrode 44, the third electrode 43, and the second heat generating portion 32. In such manner, the second heat generating portion 32 generates heat. Therefore, the first heat generating portion 31 and the second heat generating portion 32 heat the camera, radar device, lidar, headlight, and glass mounted on a vehicle (not shown), thereby ice melting, snow melting, and defogging are performable.

Here, the cross-sectional area of the fourth electrode 44 is smaller than the cross-sectional areas of the first electrode 41, the second electrode 42, and the third electrode 43 in the direction perpendicular to the direction in which the electric current flows. Therefore, the electrical resistance of the fourth electrode 44 is greater than the electrical resistances of the first electrode 41, the second electrode 42, and the third electrode 43. When an electric current flows from the first electrode connection portion 419 to the second electrode connection portion 429 via the fourth electrode 44, the third electrode 43, and the second heat generating portion 32, a voltage drop at the fourth electrode 44 is greater than the one when the electrical resistance of the fourth electrode 44 is less than or equal to the electrical resistances of the first electrode 41, the second electrode 42, and the third electrode 43. Therefore, a voltage applied to the second heat generating portion 32 is lower than a voltage applied to the first heat generating portion 31. Thus, the amount of heat generated by the second heat generating portion 32 is lower than the amount of heat generated by the first heat generating portion 31. As a result, the amount of heat generated per unit area of the second heat generating portion 32 is the same as the amount of heat generated per unit area of the first heat generating portion 31.

Further, the electric current flowing through the second electrode connection portion 429 flows to a power source (not shown) via the second lead portion 425 and the second terminal portion 427.

As described above, the film heater 10 generates heat. The sixth embodiment achieves the same and corresponding effects as the first embodiment.

### Seventh Embodiment

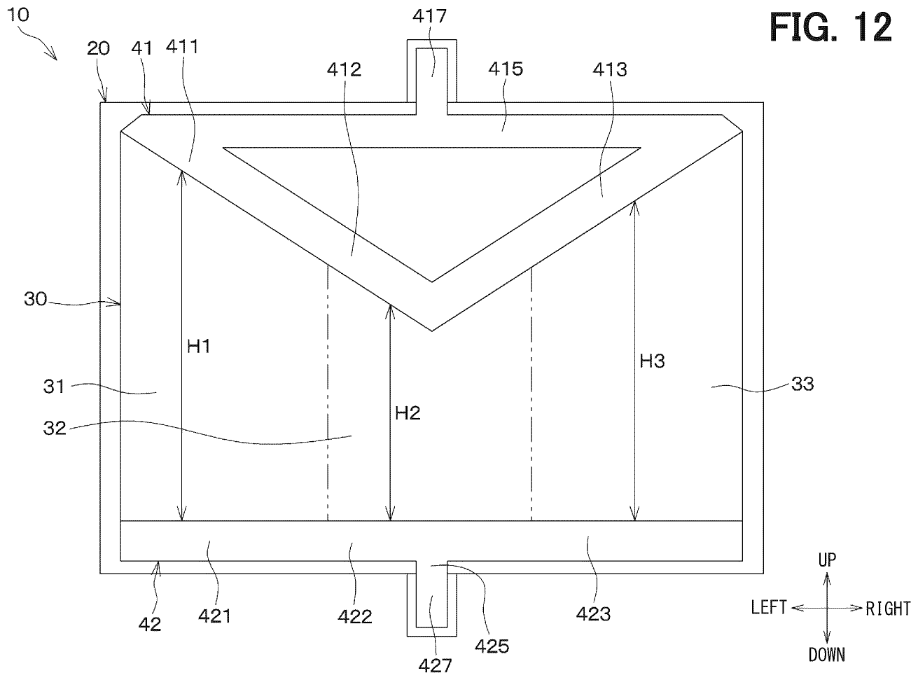

In the seventh embodiment, the form of the film heater 10 is different. A film heater 10 includes a transparent insulator 20, a transparent conductive film 30, a first electrode 41, and a second electrode 42, as shown in FIG. 12.

The transparent insulator 20 is formed similarly to the first embodiment. The transparent conductive film 30 has a first heat generating portion 31, a second heat generating portion 32, and a third heat generating portion 33. The first heat generating portion 31 is formed in a trapezoidal shape. The second heat generating portion 32 is formed in a pentagonal shape. A left side of the second heat generating portion 32 and a right side of the first heat generating portion 31 are connected. The third heat generating portion 33 is formed in a trapezoidal shape. A left side of the third heat generating portion 33 and a right side of the second heat generating portion 32 are connected. Further, the second current conduction distance H2 is shorter than the first current conduction distance H1 and the third current conduction distance H3. Further, the lengths of the first heat generating portion 31, the second heat generating portion 32, and the third heat generating portion 33 in a left-right direction are approximately the same.

The first electrode 41 is made of metal such as gold, platinum, silver, copper, or the like, as in the first embodiment. Further, the first electrode 41 is a positive electrode. Further, the first electrode 41 has a first connection portion 411, a second connection portion 412, a third connection portion 413, a first lead portion 415, and a first terminal portion 417.

The first connection portion 411 is connected to an upper side of the first heat generating portion 31. The second connection portion 412 is connected to an upper side of the second heat generating portion 32 and to a right side of the first connection portion 411. The third connection portion 413 is connected to an upper side of the third heat generating portion 33 and to a right side of the second connection portion 412. Further, the lengths and widths of the first connection portion 411, the second connection portion 412, and the third connection portion 413 are the same. Further, the thickness of the second connection portion 412 is thinner than the thicknesses of the first connection portion 411 and the third connection portion 413. Therefore, the cross-sectional area of the second connection portion 412 is smaller than the cross-sectional areas of the first connection portion 411 and the third connection portion 413, thereby the electrical resistance of the second connection portion 412 is higher than those of the first connection portion 411 and the third connection portion 413.

The first lead portion 415 is connected to the first connection portion 411 and the third connection portion 413. The first terminal portion 417 is connected to the first lead portion 415 and a power source (not shown).

The second electrode 42 is made of metal such as gold, platinum, silver, copper, or the like, as in the first embodiment. Further, the second electrode 42 is a negative electrode. Further, the second electrode 42 has a fourth connection portion 421, a fifth connection portion 422, a sixth connection portion 423, a second lead portion 425, and a second terminal portion 427.

The fourth connection portion 421 is formed in a rectangular shape. Further, the fourth connection portion 421 is connected to a lower side of the first heat generating portion 31, and extends in a left-right direction. The fifth connection portion 422 is formed in a rectangular shape. Further, the fifth connection portion 422 is connected to a lower side of the second heat generating portion 32 and a right side of the fourth connection portion 421. The sixth connection portion 423 is formed in a rectangular shape. Further, the sixth connection portion 423 is connected to a lower side of the third heat generating portion 33 and a right side of the fifth connection portion 422. Further, the lengths and widths of the fourth connection portion 421, the fifth connection portion 422, and the sixth connection portion 423 are the same. Further, the thickness of the fifth connection portion 422 is thinner than the thicknesses of the fourth connection portion 421 and the sixth connection portion 423. Therefore, the cross-sectional area of the fifth connection portion 422 is smaller than the cross-sectional areas of the fourth connection portion 421 and the sixth connection portion 423, thereby the electrical resistance of the fifth connection portion 422 is greater than those of the fourth connection portion 421 and the sixth connection portion 423.

The second lead portion 425 is connected to the fifth connection portion 422. The second terminal portion 427 is connected to the second lead portion 425 and the power source (not shown).

The seventh embodiment is configured as described above. The seventh embodiment achieves the same and corresponding effects as the first embodiment, except for [1-5] described above.

### Other Embodiments

The present disclosure is not limited to the above-described embodiments, and the above-described embodiments can be appropriately modified. Further, individual elements or features of a particular embodiment are not necessarily essential unless it is specifically stated that the elements or the features are essential in the foregoing description, or unless the elements or the features are obviously essential in principle.

In the first embodiment, the total length of the second connection portion 412 is longer than the total length of the first connection portion 411, and the width of the second connection portion 412 is smaller than the width of the first connection portion 411, thereby the electrical resistance of the second connection portion 412 is greater than the electrical resistance of the first connection portion 411. On the other hand, a situation in which the total length of the second connection portion 412 is longer than the total length of the first connection portion 411 and the width of the second connection portion 412 is smaller than the width of the first connection portion 411 does not necessarily lead to a situation in which the electrical resistance of the second connection portion 412 is greater than the electrical resistance of the first connection portion 411. The electrical resistance of the second connection portion 412 may be greater than the electrical resistance of the first connection portion 411 based at least on one of (i) the total length of the second connection portion 412 being longer than the total length of the first connection portion 411, (ii) the width of the second connection portion 412 being smaller than the width of the first connection portion 411, (iii) the thickness of the second connection portion 412 being thinner than the thickness of the first connection portion 411, and (iv) the electrical conductivity of the second connection portion 412 being lower than the electrical conductivity of the first connection portion 411.

Further, the total length of the third connection portion 413 is longer than the total length of the first connection portion 411 and the width of the third connection portion 413 is smaller than the width of the first connection portion 411, thereby the electrical resistance of the third connection portion 413 is higher than the electrical resistance of the first connection portion 411. On the other hand, a situation in which the total length of the third connection portion 413 is longer than the total length of the first connection portion 411 and the width of the third connection portion 413 is smaller than the width of the first connection portion 411 does not necessarily lead to a situation in which the electrical resistance of the third connection portion 413 is greater than the electrical resistance of the first connection portion 411. The electrical resistance of the third connection portion 413 may be greater than the electrical resistance of the first connection portion 411 based on at least one of (i) the total length of the third connection portion 413 being longer than the total length of the first connection portion 411, (ii) the width of the third connection portion 413 being smaller than the width of the first connection portion 411, (iii) the thickness of the third connection portion 413 being thinner than the thickness of the first connection portion 411, and (iv) the electrical conductivity of the third connection portion 413 being higher than the electrical conductivity of the first connection portion 411.

Further, the total length of the fifth connection portion 422 is longer than the total length of the fourth connection portion 421 and the width of the fifth connection portion 422 is smaller than the width of the fourth connection portion 421, thereby the electrical resistance of the fifth connection portion 422 is greater than the electrical resistance of the fourth connection portion 421. On the other hand, a situation in which the total length of the fifth connection portion 422 is longer than the total length of the fourth connection portion 421 and the width of the fifth connection portion 422 is smaller than the width of the fourth connection portion 421 does not necessarily lead to a situation in which the electrical resistance of the fifth connection portion 422 is greater than the electrical resistance of the fourth connection portion 421. The electrical resistance of the fifth connection portion 422 may be higher than the electrical resistance of the fourth connection portion 421 based at least on one of (i) the total length of the fifth connection portion 422 being longer than the total length of the fourth connection portion 421, (ii) the width of the fifth connection portion 422 being smaller than the width of the fourth connection portion 421, (iii) the thickness of the fifth connection portion 422 being thinner than the thickness of the fourth connection portion 421, and (iv) the electrical conductivity of the fifth connection portion 422 being lower than the electrical conductivity of the fourth connection portion 421.

Further, the total length of the sixth connection portion 423 is longer than the total length of the fourth connection portion 421 and the width of the sixth connection portion 423 is smaller than the width of the fourth connection portion 421, thereby the electrical resistance of the sixth connection portion 423 is higher than the electrical resistance of the fourth connection portion 421. On the other hand, a situation in which the total length of the sixth connection portion 423 is longer than the total length of the fourth connection portion 421 and the width of the sixth connection portion 423 is smaller than the width of the fourth connection portion 421 does not necessarily lead to a situation in which the electrical resistance of the sixth connection portion 423 is greater than the electrical resistance of the fourth connection portion 421. The electrical resistance of the sixth connection portion 423 may be greater than the electrical resistance of the fourth connection portion 421 based at least on one of (i) the total length of the sixth connection portion 423 being longer than the total length of the fourth connection portion 421, (ii) the width of the sixth connection portion 423 being smaller than the width of the fourth connection portion 421, (iii) the thickness of the sixth connection portion 423 is thinner than the thickness of the fourth connection portion 421, and (iv) the electrical conductivity of the sixth connection portion 423 being lower than the electrical conductivity of the fourth connection portion 421.

In the first embodiment, the electrical resistances of the second connection portion 412 and the third connection portion 413 are higher than the electrical resistance of the first connection portion 411, and the electrical resistances of the fifth connection portion 422 and the sixth connection portion 423 are higher than the electrical resistance of the connection portion 421. On the other hand, a situation in which (a) the electrical resistances of the second connection portion 412 and the third connection portion 413 are higher than the electrical resistance of the first connection portion 411 and (b) the electrical resistances of the fifth connection portion 422 and the sixth connection portion 423 are higher than the electrical resistance of the fourth connection portion is not necessarily limiting. There may be a situation in which (a) the electrical resistances of the second connection portion 412 and the third connection portion 413 are higher than the electrical resistance of the first connection portion 411, and (b) the electrical resistances of the fifth connection portion 422 and the sixth connection portion 423 are equal to the electrical resistance of the fourth connection portion 421.

There may be a situation in which (a) the electrical resistances of the fifth connection portion 422 and the sixth connection portion 423 are higher than the electrical resistance of the fourth connection portion 421, and (b) the electrical resistances of the second connection portion 412 and the third connection portion 413 are higher than the electrical resistance of the first connection portion 411. In such case, the second electrode 42 corresponds to a first electrode. The fourth connection portion 421 corresponds to a first connection portion. The fifth connection portion 422 corresponds to a second connection portion. The second lead portion 425 and the second terminal portion 427 correspond to a lead portion.

In the above-described embodiments, the first electrode 41 is a positive electrode, and the second electrode 42 is a negative electrode. On the other hand, the first electrode 41 may be a negative electrode, and the second electrode 42 may be a positive electrode.

The above embodiments may be combined as appropriate.

What is claimed is:

1. A film heater comprising:
a transparent conductive film including
a first heat generating portion configured to generate heat when energized and to transmit light therethrough, and
a second heat generating portion configured to generate heat when energized and to transmit light therethrough;
a first electrode including
a first connection portion connected to the first heat generating portion, and
a second connection portion connected to the second heat generating portion and the first connection portion; and
a second electrode facing the first connection portion and connected to the first heat generating portion and the second heat generating portion, wherein
a length of a path of an electric current flowing through the second heat generating portion is shorter than a length of a path of an electric current flowing through the first heat generating portion, and
an electrical resistance of the second connection portion is higher than the electrical resistance of the first connection portion.

2. The film heater of claim 1, wherein
a length of a path of the electric current flowing through the second connection portion is longer than a length of a path of the electric current flowing through the first connection portion.

3. The film heater of claim 1, wherein
a thickness of the second connection portion in a direction that is perpendicular to both of a direction of the electric current flowing through the second connection portion and a surface of the transparent conductive film is thinner than a thickness of the first connection portion in a direction that is perpendicular to both of a direction of the electric current flowing through the first connection portion and a surface of the transparent conductive film.

4. The film heater of claim 1, wherein
a width of the second connection portion in a width direction, which is perpendicular to a direction of the electric current flowing through the second connection portion and along which a surface of the transparent conductive film extends, is smaller than a width of the first connection portion in a width direction, which is perpendicular to a direction of the electric current flowing through the first connection portion and along which a surface of the transparent conductive film extends.

5. The film heater of claim 1, wherein
the second connection portion has a lower electrical conductivity than the first connection portion.

6. The film heater of claim 1, wherein
the first electrode further includes a lead portion connected to the first connection portion and a power source.
